(19) United States
(12) Patent Application Publication
(10) Pub. No.: US 2011/0016141 A1
(43) Pub. Date: Jan. 20, 2011

(54) Web Traffic Analysis Tool

(75) Inventors: Doron Bar-Caspi, Redmond, WA (US); Kai Zhu, Beijing (CN); Daniel K. Winter, Monroe, WA (US); Demetrios Kalligerakis, Sammamish, WA (US); Kfir Ami-Ad, Redmond, WA (US); Yi Sui, Beijing (CN); Wenyu Cai, Redmond, WA (US); Michael Anthony Wise, Langen (DE)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/891,826

(22) Filed: Sep. 28, 2010

Related U.S. Application Data
(63) Continuation of application No. PCT/US2009/040616, filed on Apr. 15, 2009.
(60) Provisional application No. 61/045,046, filed on Apr. 15, 2008.

(51) Int. Cl. G06F 17/30

(52) U.S. Cl. 707/758; 707/E17.005

(57) ABSTRACT

A log file may include a line corresponding to a request received at a web server. A rules file may include rules that are applied in a specified order. The rules may include a first rule associated with a first request identifier and a second rule associated with a second request identifier. A determination is made as to whether the line matches the first rule. If the line matches the first rule, then identification data is updated to associate the first request identifier with the line. If the line does not match the first rule, then a determination is made as to whether the line matches the second rule. If the line matches the second rule, then the identification data is updated to associate the second request identifier with the line. If the line does not match the second rule, additional rules in the rules may be similarly applied

### BACKGROUND

Generally, World Wide Web (“web”) servers are configured to handle transactions, such as Hypertext Transfer Protocol (“HTTP”) transactions and File Transfer Protocol (“FTP”) transactions, for accessing online content. Web servers may receive requests from one or more client computers over a computer network, such as the Internet. In response to those requests, the web servers may provide the requested websites to the client computers. For example, a user may access a web browser executing on a personal computer and enter a particular Universal Resource Locator (“URL”). The web server may then return a web page corresponding to the URL to the web browser. The web page may include or reference Hypertext Markup Language (“HTML”), Cascading Style Sheets (“CSS”), JavaScript, images, and/or other types of content.

The web server may include log functionality for recording various log data related to each transaction. For example, this log data may include the Internet Protocol (“IP”) address of connected clients, the user's username, a date and time of a request, one or more status codes, a number of bytes received, an elapsed time to handle the request, a number of bytes sent, a type of action (e.g., a GET command), and a target file. The log functionality may generate log files containing the log data.

A web server administrator may find the log data to be useful for analyzing the number and type of transactions that are handled by a corresponding web server. For example, the web server administrator may analyze the log data in order determine whether the current web server has the capacity to handle the current load. In this way, the web server administrator can make decisions as to whether the current web server should be upgraded.

Depending on the volume of transactions that are handled by a given web server, the size of corresponding log files can be substantial. As a result, manual review and analysis of such large log files can be time-consuming and tedious. Further, conventional automated approaches for analyzing log files can be inefficient and suboptimal for some applications.

It is with respect to these considerations and others that the disclosure made herein is presented.

### SUMMARY

Technologies are described herein for analyzing web traffic. Through the utilization of the technologies and concepts presented herein, a web traffic analysis tool may be configured to identify requests within a web server log file. The web server log file may include multiple lines, each of which corresponds to a different web server request. A rules file may contain a sequence of rules, each of which identifies a type of request for each line in the web server log. Each rule may identify the type of request based on values of one or more attributes contained in each line.

For each line in the web server log file, the web traffic analysis tool may sequentially apply each rule in the sequence of rules according to a specified order. When the web traffic analysis tool reaches a rule that matches a given line, the web traffic analysis tool may identify the line with the type of request corresponding to the rule and disregard the remainder of the rules in the sequence of rules. Until the web traffic analysis tool reaches a rule that matches the line, the web traffic analysis tool may continue to apply additional rules in the sequence of rules according to the specified order.

Upon identifying the requests for one or more web server log files, the web traffic analysis tool may generate an output file. The output file may contain counts and/or ratios for each type of request contained in the web server log file in relation to a given total number of requests. A web server administrator managing a web server can easily review the output file to determine a total number of requests handled by the web server, the types of requests handled by the web server, and the ratios of various types of requests against the whole.

In an example technology, a computer having a memory and a processor is configured to analyze web traffic. The computer receives a log file. The log file may include at least a line. The line may correspond to a request received at a web server. The computer also receives a rules file. The rule file may include a sequence of one or more rules that are applied in a specified order. The sequence of rules may be with a plurality of request identifiers. The sequence of rules may include, among any number of rules, a first rule associated with a first request identifier and a second rule associated with a second request identifier.

The computer determines whether the line matches the first rule. If the computer determines that the line matches the first rule, then the computer updates identification data to associate the first request identifier with the line. If the computer determines that the line does not match the first rule, then the computer determines whether the line matches the second rule. If the computer determines that the line matches the second rule, then the computer updates the identification data to associate the second request identifier with the line. If the line does not match the second rule, additional rules in the rules may be similarly applied

It should be appreciated that the above-described subject matter may also be implemented as a computer-controlled apparatus, a computer process, a computing system, or as an article of manufacture such as a computer-readable storage medium. These and various other features will be apparent from a reading of the following Detailed Description and a review of the associated drawings.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a network architecture diagram illustrating a network architecture configured to receive and analyze web traffic, in accordance with some embodiments;

FIG. 2 is a file format diagram showing an illustrative implementation of a log file, in accordance with some embodiments;

FIG. 3 is a file format diagram showing an illustrative implementation of a rules file, in accordance with some embodiments;

FIG. 4 is a file format diagram showing an illustrative implementation of the output file, in accordance with some embodiments;

FIGS. 5A and 5B are data structure diagrams showing illustrative implementations of rules, in accordance with some embodiments;

FIG. 6 is a flow diagram illustrating a method for analyzing web traffic, in accordance with some embodiments; and

FIG. 7 is a computer architecture diagram showing an illustrative computer hardware architecture for a computing system capable of implementing the embodiments presented herein.

### DETAILED DESCRIPTION

The following detailed description is directed to technologies for analyzing web traffic. In accordance with some embodiments described herein, a web traffic analysis tool may be configured to analyze a log file containing one or more lines, each of which may correspond to a web server request received at a web server. The web traffic analysis tool may analyze the log file to identify the occurrence of different types of web server requests.

The web traffic analysis tool may sequentially apply rules from a rules file to each line in the log file according to a specified order. Each rule may be associated with a type of web server request. When a given rule matches a line, the web traffic analysis tool may note the occurrence of the type of web server request corresponding to the given rule. Upon noting the occurrence of different types of web server requests from a total number of web server requests, the web traffic analysis tool can generate an output file that presents ratios of each type of web server request in relation to the total number of web server requests.

While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

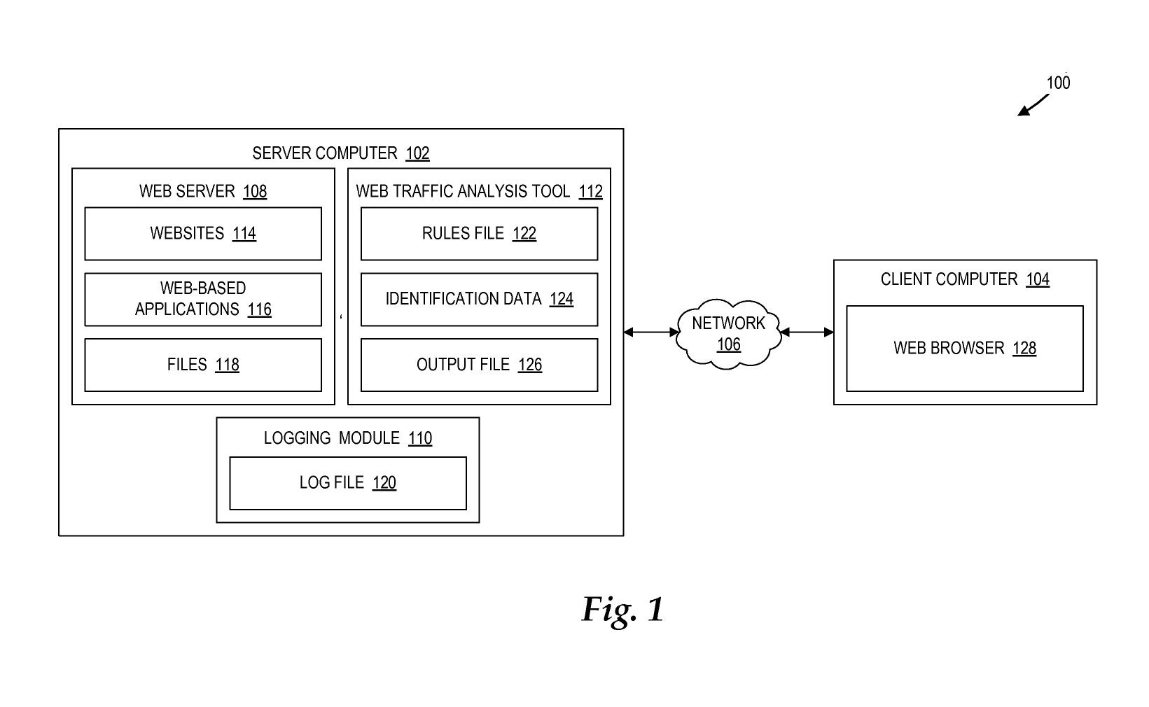

In the following detailed description, references are made to the accompanying drawings that form a part hereof, and which are shown by way of illustration, specific embodiments, or examples. Referring now to the drawings, in which like numerals represent like elements through the several figures, a computing system and methodology for analyzing web traffic will be described. In particular, FIG. 1 illustrates an example computer network architecture 100 configured to receive and analyze web traffic, in accordance with some embodiments. The computer network architecture 100 may include a server computer 102 and a client computer 104 coupled via a network 106. The network 106 may be any suitable computer network, such as a local area network (“LAN”), a personal area network (“PAN”), or the Internet.

The server computer 102 may include a web server 108, a logging module 110, and a web traffic analysis tool 112. The web server 108 may include one or more websites 114, one or more web-based applications 116, one or more files 118, and/or other online content. The web traffic analysis tool 112 may include a log file 120, a rules file 122, identification data 124, and an output file 126. The client computer 104 may include a web browser 128, a rich client (e.g., an office productivity application), a Web-based Distributed Authoring and Versioning (“WEBDAV”) client, or other suitable application capable of sending requests to the web server 108. The web traffic analysis tool 112 may be executed on another computer. The web traffic analysis tool 112 may analyze log files on other computers. The log file 120 may be contained in a folder of log files. The log file 120 may also be partitioned into multiple files in order to avoid having too large a single file.

According to some embodiments, a user may utilize the web browser 128 to access the online content provided by the web server 108. For example, the web browser 128 may transmit requests for the websites 114, the web-based applications, and/or the files 118 to the web server 108. Upon receiving the requests, the web server 108 may process those requests and grant or deny access to the requested online content.

While the web server 108 is handling transactions, such as receiving and responding to the requests, the logging module 110 may be configured to record these transactions in the log file 120. An example format for the log file 120 is the W3C extended log file format. Other suitable formats may include publicly available formats as well as proprietary formats. The log file 120 may include a plurality of lines corresponding to a plurality of requests. In one embodiment, each request in the log file 120 is embodied in a single line. Thus, if the log file 120 includes a thousand requests, then the log file 120 may include a thousand lines, each of which corresponds to one of the requests. The lines may be separated by a carriage return (“CR”), a carriage return line feed (“CRLF”), or the like. The log file 120 may be a text file, a binary file, or other suitable file type.

The lines may correspond to one or more fields. In particular, each line may contain one or more values, each of which corresponds to one of the fields. The fields may correspond to a particular attribute of the corresponding request. The values may include numerical values and/or strings. Each value may be separated by whitespace or other suitable separating indicator. Some of the lines may not contain values for one or more of the fields. For example, some lines may contain null values in such fields.

In an illustrative example, the W3C extended log file format may include one or more of the following fields: date, time, service name, server Internet Protocol (“IP”) address, method, Uniform Resource Identifier (“URI”) stem, URI query, server port, user name, client IP address, user agent, protocol status, protocol substatus, and WIN32 status. Other suitable fields may be similarly implemented. The date field (commonly labeled “date”) may specify a date of the request. The time field (commonly labeled “time”) may specify time of the request. The service name field (commonly labeled “s-sitename”) may specify an Internet service and instance number accessed by the client computer 104. The server IP address field (commonly labeled “s-ip”) may specify the IP address of the server computer 102 on which the log file 120 is generated.

The method field (commonly labeled “cs-method”) may specify an action that the client computer 104 is requesting. Examples of such actions may include GET operations, LOCK operations, PROPFIND operations, POST operations, HEAD operations, and the like. The URI stem field (commonly labeled “cs-uri-stem”) may specify a resource (e.g., default.aspx, index.htm, etc.) that is requested. The URI query field (commonly labeled “cs-uri-query”) may specify a query, if any, requested by the client computer 104. The server port field (commonly labeled “s-port”) may specify a port number to which the client computer 104 is connected. The user name field (commonly labeled “cs-username”) may specify a name of an authenticated user transmitting the request. The client IP address field (commonly labeled “c-ip”) may specify the IP address of the client computer 104 transmitting the request. The user agent field (commonly labeled “cs(User-Agent)”) may specify a type of the web browser 128 transmitting the request from the client computer 104.

The protocol status field (commonly labeled “sc-status”) may specify a status of the action identified in the method field. The status may correspond to HTTP and/or FTP status codes. For example, the HTTP status code “401” may indicate failure of the request, and the HTTP status code “200” may indicate success of the request. The protocol substatus field (commonly labeled “sc-substatus”) may further specify a substatus when the status identified in the protocol status field is an error code. For example, while the HTTP status code “401” generally indicates failure of the request, a corresponding substatus value of “1” may further indicate that the failure of the request was due to a logon failure. When the status identified in the protocol status field is not an error code, the substatus value may be “0”. The WIN32 status field (commonly labeled “sc-win32-status”) may specify a status, in terms of MICROSOFT WINDOWS, of the action identified in the method field. For example, the WIN32 status may be utilized in log files generated by MICROSOFT INTERNET INFORMATION SERVICES.

When the logging module 110 generates the log file 120, the logging module 110 may provide the log file 120 to the web traffic analysis tool 112. The web traffic analysis tool 112 may be configured to analyze the log file 120. In particular, the web traffic analysis tool 112 may apply the rules file 122 to each line within the log file 120 in order to generate the identification data 124 that associates a particular request identifier to each line in the log file 120. The rules files 122 may include one or more rules that are matched to each line in the log file 120. These rules may be encoded in Extensible Markup Language (“XML”) or other suitable encoding technique. Upon identifying the requests in the log file 120, the web traffic analysis tool 112 may generate the output file 126 based on the identification data 124. The output file 126 may be a text file, a binary file, a comma-separated values (“CSV”) file, or other suitable file type.

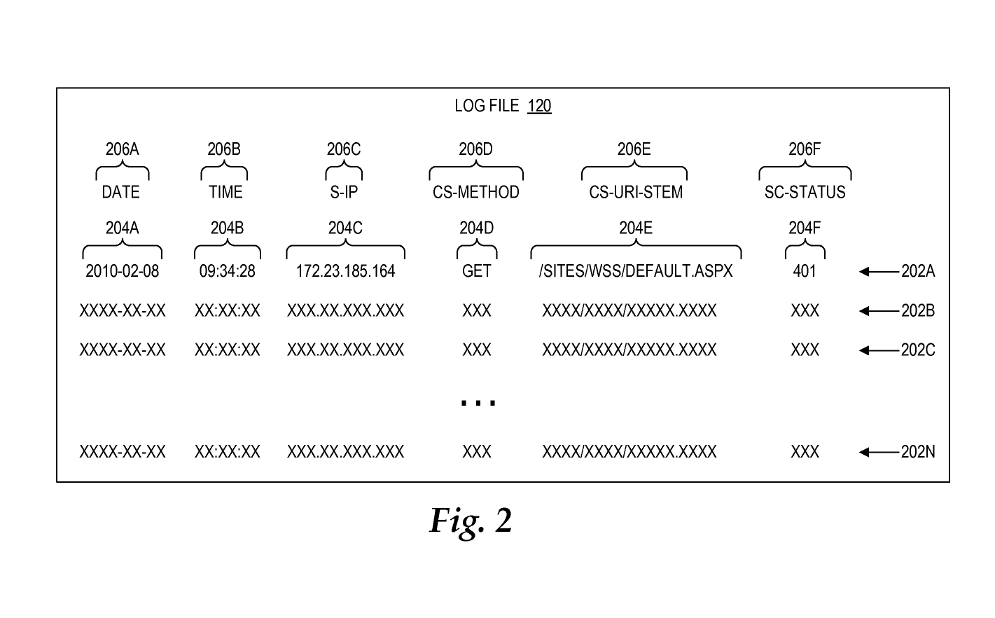

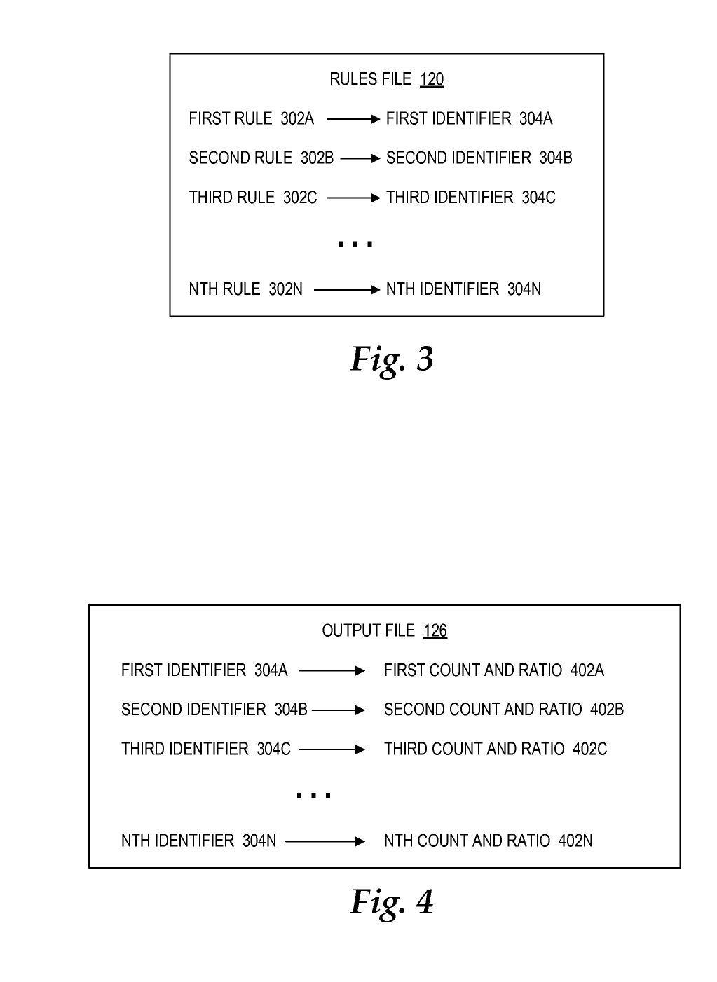

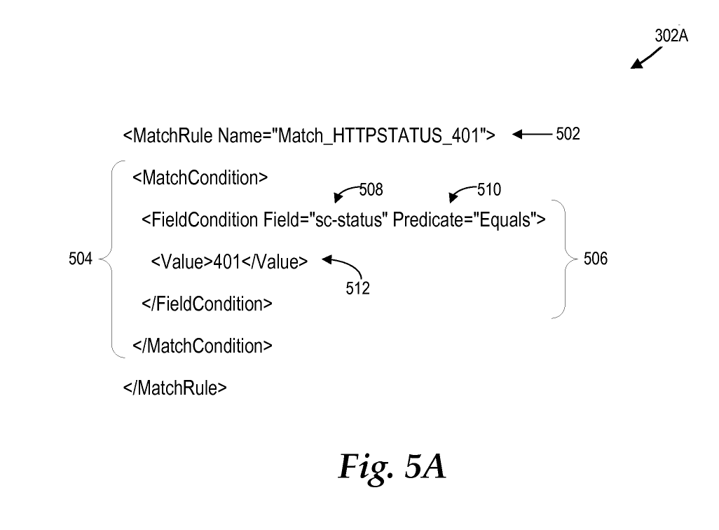

Referring now to FIGS. 2-4, additional details will be provided regarding the log file 120, the rules file 122, and the output file 126. In particular, FIG. 2 is a diagram showing an illustrative implementation of the log file 120, in accordance with some embodiments. FIG. 3 is a diagram showing an illustrative implementation of the rules file 122, in accordance with some embodiments. FIG. 4 is a diagram showing an illustrative implementation of the output file 126, in accordance with some embodiments.

As illustrated in FIG. 2, the log file 120 may include one or more lines, such as a first line 202A, a second line 202B, a third line 202C, and an Nth line 202N. The lines 202A-202N may be collectively referred to as lines 202. As previously described, each of the lines 202 may correspond to a particular request received at the web server 108. Each of the lines 202 may include one or more values, such as a first value 204A, a second value 204B, a third value 204C, a fourth value 204D, a fifth value 204E, and a sixth value 204F. The values 204A-204F may be collectively referred to as values 204. Each of the values 204 one or more fields, such as a first field 206A, a second field 206B, a third field 206C, a fourth field 206D, a fifth field 206E, and a sixth field 206F. The fields 206A-206F may be collectively referred to as fields 206. The values 204A-204F may correspond to the fields 206A-206F, respectively. In other embodiments, the log file 120 may include more or less fields, as well as different types of fields.

The first field 206A may correspond to the date field. For example, in the first line 202A, the first value 204A under the first field 206A is a date, “2010-02-08”. The second field 206B may correspond to the time field. For example, in the first line 202A, the second value 204B under the second field 206B is a time, “09:34:28”. The third field 206C may correspond to the server IP address. For example, in the first line 202A, the third value 204C under the third field 206C is an IP address, “172.23.185.164”. The fourth field 206D may correspond to the method field. For example, in the first line 202A, the fourth value 204D under the fourth field 206D is the GET operation. The fifth field 206E may correspond to the URI stem field. For example, in the first line 202A, the fifth value 204E under the fifth field 206E is the URI stem, “/sites/wss/default.aspx”. The sixth field 206F may correspond to the protocol status field. For example, in the first line 202A, the sixth value 204F under the sixth field 206F is the HTTP status code, “401”.

As illustrated in FIG. 3, the rules file 122 may include a sequence of one or more rules, such as a first rule 302A, a second rule 302B, and an Nth rule 302N. The rules 302A-302N may be collectively referred to as rules 302. Each of the rules 302 may correspond to one of a plurality of request identifiers 304A-304N for identifying a given request. In particular, the first rule 302A may correspond to the first request identifier 304A. The second rule 302B may correspond to the second request identifier 304B. The third rule 302C may correspond to the third request identifier 304C. The Nth rule 302N may correspond to the Nth request identifier 304N. The request identifiers 304A-304N may be collectively referred to as request identifiers 304.

The rules 302 may be arranged in a specified order (i.e., the first rule 302A, then the second rule 302B, then the third rule 302BC, and so forth). The specified order may correspond to the order of the sequence of the rules 302. The web traffic analysis tool 112 may be configured to apply the rules 302 in this specified order. That is, for each of the lines 202 within the log file 120, the web traffic analysis tool 112 may apply the rules 302 in the specified order. For example, the web traffic analysis tool 112 may begin with the first rule 302A, which is associated with the first request identifier 304A. The web traffic analysis tool 112 may determine whether the first rule 302A matches the first line 202A in the log file 120. If the first rule 302A matches the first line 202A, then the web traffic analysis tool 112 may update the identification data 124 to indicate that the first line 202A is associated with the first request identifier 304A. At this point, the web traffic analysis tool 112 may disregard the remainder of the rules 302 in the sequence. The web traffic analysis tool 112 may then proceed to analyzing the second line 202B in the log file 120 starting again from the first rule 302A according to the specified order.

If the first rule 302A does not match the first line 202A in the log file 120, then the web traffic analysis tool 112 may proceed to the next rule according to the specified order. In this example, the next rule is the second rule 302B. Thus, the web traffic analysis tool 112 may determine whether the second rule 302B matches the first line 202A in the log file 120. If the second rule 302B matches the first line 202A, then the web traffic analysis tool 112 may update the identification data 124 to indicate that the first line 202A is associated with the second request identifier 304B. Again, at this point, the web traffic analysis tool 112 may disregard the remainder of the rules 302 in the sequence. The web traffic analysis tool 112 may then proceed to analyzing the second line 202B in the log file 120 starting again from the first rule 302A according to the specified order.

If the second rule 302B does not match the first line 202A in the log file 120, then the web traffic analysis tool 112 may proceed to the next rule according to the specified order. In this example, the next rule is the third rule 302C. The web traffic analysis tool 112 may traverse through each of the rules 302 in the specified order until a rule is reached that matches the first line 202A. Once the web traffic analysis tool 112 reaches the rule that matches the first line 202A, the web traffic analysis tool 112 may then proceed to analyzing the second line 202B in the log file 120 starting again from the first rule 302A according to the specified order.

The specified order of the rules 302 may be configured according to any suitable criteria. In one embodiment, the specified order of the rules 302 may be configured such that more definite rules are placed at the beginning of the specified order and less definite rules are placed at the end of the specified order. In another embodiment, the specified order of the rules 302 may be configured such that rules having a higher priority are placed at the beginning of the specified order and rules having a lower priority are placed at the end of the specified order.

In yet another embodiment, the specified order of the rules 302 may be configured such that dependencies between the fields 206 are eliminated by the specified order. For example, a first rule may be satisfied by a given line if a first value under a first field is equal to “XXX” and a second value under a second field is equal to “YYY”. Further, a second rule may be satisfied by a given line if the first field is equal to “XXX”. In this example, if, according to the specified order, the web traffic analysis tool 112 applies the second rule before the first rule, then the web traffic analysis tool 112 will not reach the first rule if a given line satisfies the second rule. In contrast, if, according to the specified order, the web traffic analysis tool 112 applies the first rule before the second rule, then the web traffic analysis tool 112 can determine whether a given line satisfies the more specific first rule. If the given line does not satisfy the more specific first rule, then the web traffic analysis tool 112 can determine whether the given line satisfies the more general second rule.

According to some embodiments, each of the rules 302 may include one or more field conditions. A rule may also have an empty condition, in which case, each line matches this rule. A rule may match a given line if one or more of the field conditions are satisfied by the given line. Each of the field conditions may include at least three elements: a field element, a pattern element, and a predicate element. The field element may identify at least one of the fields 206. The pattern element may specify a pattern, which can be a numerical value and/or a string. The predicate element may specify a predicate.

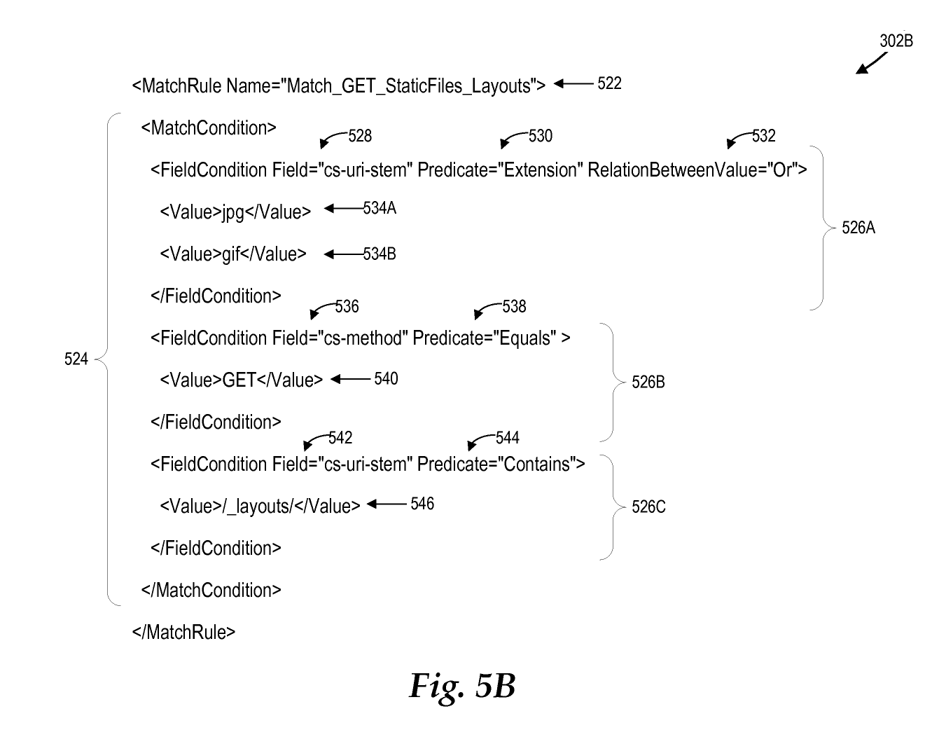

A given line may include a value corresponding to the identified field in the field element. The given line satisfies a field condition if this value and the specified pattern in the pattern element have a relation as specified by the predicate. In illustrative field condition, the field element may identify the URI stem field, and the pattern element may specify “directory.aspx”. Further, predicate element may specify “NotEndsWith”. A given line may satisfy this field condition if the value under the URI stem field of the given line does not end with directory.aspx. For example, the value under the fifth field 206E (i.e., the URI stem field) in the second line 202B may be “/directory/directory.aspx”. The second line 202B does not satisfy the field condition because the value under the fifth field 206E in the second line 202B ends in directory.aspx. In another example, the value under the fifth field 206E in the third line 202C may be “/folder/default.aspx”. The third line 202C satisfies the field condition because the value under the fifth field 206E in the third line 202C does not end in directory.aspx. The rules 302 and the field conditions will be described in greater detail below with reference to FIGS. 5A-5B.

As illustrated in FIG. 4, each of the identifiers 304 may be associated with one of a plurality of counts and ratios 402A-402N. In particular, the first request identifier 304A may be associated with the first count and ratio 402A. The second request identifier 304B may be associated with the second count and ratio 402B. The third request identifier 304C may be associated with the third count and ratio 402C. The Nth request identifier 304N may be associated with the Nth count and ratio 402N. The counts and ratios 402A-402N may be collectively referred to as counts and ratios 402. The counts and ratios 402 may be encoded as a quantity, a percentage, and/or the like.

Each of the counts and ratios 402 may include a count and a ratio. The count may specify a number of times that a particular request, as specified by the request identifiers 304, is received by the web server 108. The ratio may specify the number of times that a particular request, as specified by the request identifiers 304, is received by the web server 108 in relation to a total number of requests received by the web server 108. In an example, the web server 108 may receive one hundred requests, which the logging module 110 records in the log file 120. The web traffic analysis tool 112 may apply the rules file 122 to the log file 120 and determine that thirty of the one hundred requests satisfy the first rule 302A in the rules file 122. In this example, the output file 126 may specify that the first request identifier 304A is associated with a count of thirty and a ratio of 0.3 or thirty percent.

Referring now to FIGS. 5A and 5B, additional details will be provided regarding an illustrative structure of the rules 302 and the identifiers 304. In particular, FIG. 5A shows an illustrative implementation of one of the rules 302, such as the first rule 302A. FIG. 5B shows an illustrative implementation of another one of the rules 302, such as the second rule 302B. In FIG. 5A, the first rule 302A may include a match rule name 502, which may correspond to the first identifier 304A. In this example, the match rule name 502 is “Match_HTTPSTATUS_{—}401”. The first rule 302A may further include a match condition 504. If a given line satisfies the match condition 504, then the web traffic analysis tool 112 may determine that the given line matches the first rule 302A.

The match condition 504 may include one or more field conditions, such as a field condition 506. The field condition 506 may identify a condition to be satisfied by one or more of the values 204 in the log file 120. As illustrated in FIG. 5A, the field condition 506 contains three elements: a field element 508, a predicate element 510, and a pattern element 512. The field element 508 may identify one of the fields 206. The pattern element 512 may specify a pattern. The predicate element 510 may specify a predicate. In this example, the identified field is the protocol status field, and the specified pattern is “401”. The specified predicate is “Equals”. As such, a given line matches the first rule 302A if the value under the protocol status field in the given line equals 401.

In FIG. 5B, the second rule 302B may include a match rule name 522, which may correspond to the second identifier 304B. In this example, the match rule name 522 is “Match_GET_StaticFiles_Layouts,” which may correspond to the second identifier 304B. The second rule 302B may further include a match condition 524. If a given line satisfies the match condition 524, then the web traffic analysis tool 112 may determine that the given line matches the second rule 302B.

The match condition 504 may include one or more field conditions, such as a first field condition 526A, a second field condition 526B, and a third field condition 526C. The field conditions 526A-526C may be collectively referred to as field conditions 526. In one embodiment, a given line matches the second rule 302B if the given line satisfies each of the field conditions 526 (e.g., a logical conjunction). In another embodiment, a given line matches the second rule 302B even if the given line satisfies only a subset of the field conditions 526 is satisfied (e.g., a logical disjunction). The logical connective (e.g., logical conjunction, logical disjunction, etc.) may be implied or specified within the rule. Further, other logical connectives may be similarly utilized.

As illustrated in FIG. 5B, the first field condition 526A contains five elements: a field element 528, a predicate element 530, a relation between values element 532, a first pattern element 534A, and a second pattern element 534B. The relation between values element may specify a logical conjunction (e.g., “AND”), a logical disjunction (e.g., “OR”), or some other logical connective. The relation between values element may indicate the way in which the first pattern element 534A and the second pattern element 534B are evaluated. In this example, the identified field is the URI stem field, and the specified predicate is “Extension”. The specified relation between values is “OR”. The specified first pattern is “jpg”, and the specified second pattern is “gif”. As such, a given line satisfies the first field condition 526A if the value under the URI stem field in the given line has a file extension of .jpg or .gif.

The second field condition 526B contains three elements: a field element 536, a predicate element 538, and a pattern element 540. In this example, the identified field is the method field, and the specified pattern is “GET”. The specified predicate is “Equals”. As such, a given line satisfies the second field condition 526B if the value under the method field in the given line is equal to “GET”. The third field condition 526C contains three elements: a field element 542, a predicate element 544, and a pattern element 546. In this example, the identified field is the URI stem field, and the specified pattern is “/layouts/”. The specified predicate is “Contains”. As such, a given line satisfies the third field condition 426C if the value under the URI stem field in the given line contains /layouts/.

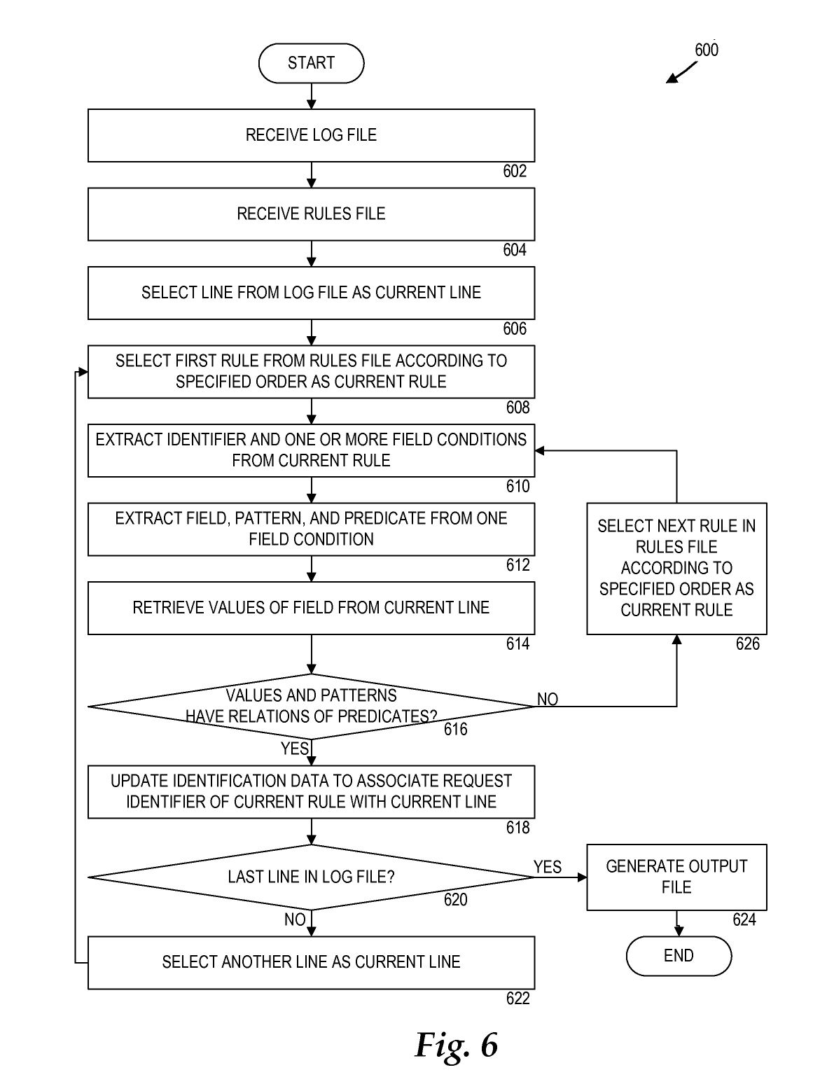

Referring now to FIG. 6, additional details regarding the operation of the web traffic analysis tool 112. In particular, FIG. 6 is a flow diagram illustrating a method for analyzing web traffic, in accordance with some embodiments. It should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states operations, structural devices, acts, or modules. These operations, structural devices, acts, and modules may be implemented in software, in firmware, in special purpose digital logic, and any combination thereof. It should be appreciated that more or fewer operations may be performed than shown in the figures and described herein. These operations may also be performed in a different order than those described herein.

In FIG. 6, a routine 600 begins at operation 602, where the web traffic analysis tool 112 receives the log file 120. For example, the logging module 110 may collect requests received at the web server 108 and generate the log file 120. As previously described, the log file 120 may include one or more lines, and each line in the log file 120 may correspond to a particular request received at the web server 108. Further, each line may include a plurality of values, each of which may correspond to a particular field. When the web traffic analysis tool 112 receives the log file 120, the routine 600 proceeds to operation 604.

At operation 604, the web traffic analysis tool 112 receives the rules file 122. As previously described, the rules file 122 may include a sequence of rules that the web traffic analysis tool 112 applies in a specified order. Each rule may be associated with a request identifier and include at least one field condition. Each field condition may include a field element, a predicate element, and a pattern element. The field element may identify a field in the log file 120, and the pattern element may specify a pattern. The predicate element may specify a predicate between the value of the identified field in the log file 120 and the specified pattern. When the web traffic analysis tool 112 receives the rules file 122, the routine 600 proceeds to operation 606.

At operation 606, the web traffic analysis tool 112 selects, as a current line, a line in the log file 120. The routine 600 then proceeds to operation 608, where the web traffic analysis tool 112 selects, as a current rule, a first rule in the rules file 122 according to the specified order. The routine 600 then proceeds to operation 610, where the web traffic analysis tool 112 extracts the request identifier and the one or more field conditions from the current rule. The routine 600 then proceeds to operation 612, where the web traffic analysis tool 112 extracts a field from the field element, a predicate from the predicate element, and a pattern from the pattern element from each of the extracted field conditions. When the web traffic analysis tool 112 extracts an identified field from the field element, a predicate from the predicate element, and a pattern from the pattern element from each of the extracted field conditions, the routine 600 proceeds to operation 614.

At operation 614, the web traffic analysis tool 112 retrieves the values of the extracted fields from the current line. The routine 600 then proceeds to operation 616, where the web traffic analysis tool 112 determines whether the retrieved values and the extracted patterns have relations corresponding to the extracted predicates. In some embodiments, the web traffic analysis tool 112 may determine whether the retrieved values and the extracted patterns have relations corresponding to at least one the extracted predicates (e.g., a logical disjunction). In some other embodiments, the web traffic analysis tool 112 may determine whether the retrieved values and the extracted patterns have relations corresponding to each of the extracted predicates (e.g., a logical conjunction).

If the web traffic analysis tool 112 determines that the retrieved values and the extracted patterns have relations corresponding to the extracted predicates, then the routine 600 proceeds to operation 618, where the web traffic analysis tool 112 updates the identification data 124 to associate the request identifier of the current rule with the current line. By updating the identification data 124, the web traffic analysis tool 112 may transform the identification data 124 from a first state that does not associate the request identifier of the current rule with the current line to a second state that associates the request identifier of the current rule with the current line. The routine 600 then proceeds to operation 620, where the web traffic analysis tool 112 determines whether each of the lines in the log file 120 has been analyzed. If the web traffic analysis tool 112 determines that the each of the lines in the log file 120 has been analyzed, then the routine 600 proceeds to operation 624, where the web traffic analysis tool 112 generates the output file 126 based on the identification data 124. As previously described, the output file 126 may associate ratios, such as percentages, for each type of request that has been identified in relation to a total number of requests received at the web server 108. When the web traffic analysis tool 112 generates the output file 126 based on the identification data 124, the routine 600 ends.

If the web traffic analysis tool 112 determines that each of the lines in the log file 120 have not been analyzed, then the routine 600 proceeds to operation 622, where the web traffic analysis tool 112 selects, as the current line, another line from the log file 120 that has not been analyzed. The routine 600 then proceeds back to operation 608, where the where the web traffic analysis tool 112 selects, as a current rule, a first rule in the rules file 122 according to the specified order. In particular, operations 608-622 may be repeated as necessary until each of the lines in the log file 120 has been analyzed.

If the web traffic analysis tool 112 determines that the retrieved value and the pattern do not have the relation corresponding to the predicate, then the routine 600 proceeds to operation 626, where the web traffic analysis tool 112 selects, as the current rule, a next rule in the sequence of rules according to the specified order. For example, the next rule in the specified order after the first rule may be the second rule. The routine 600 then proceeds back to operation 610.

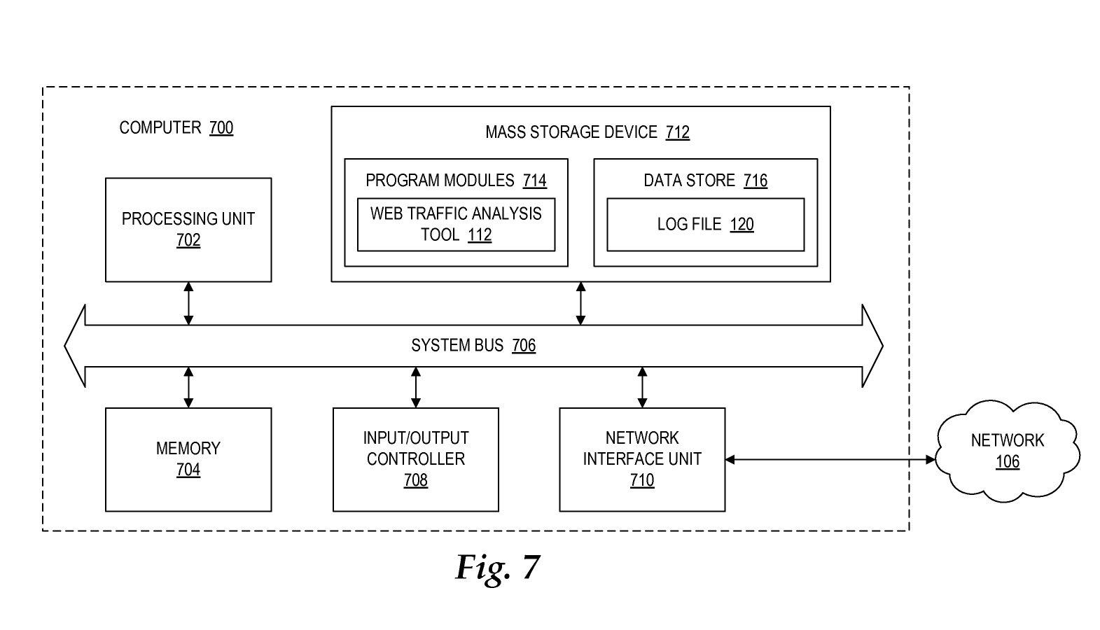

Turning now to FIG. 7, an example computer architecture diagram showing a computer 700 is illustrated. Examples of the computer 700 may include the server computer 102 and the client computer 104. The computer 700 may include a central processing unit (“CPU”) 702, a system memory 704, and a system bus 706 that couples the memory 704 to the CPU 702. The computer 700 may further include a mass storage device 712 for storing one or more program modules 714 and a data store 716. An example of the program modules 714 may include the web traffic analysis tool 112. The data store 716 may store the log file 120. The mass storage device 712 may be connected to the CPU 702 through a mass storage controller (not shown) connected to the bus 706. The mass storage device 712 and its associated computer-storage media may provide non-volatile storage for the computer 700. Although the description of computer-storage media contained herein refers to a mass storage device, such as a hard disk or CD-ROM drive, it should be appreciated by those skilled in the art that computer-storage media can be any available computer storage media that can be accessed by the computer 700.

By way of example, and not limitation, computer-storage media may include volatile and non-volatile, removable and non-removable media implemented in any method or technology for the non-transitory storage of information such as computer-storage instructions, data structures, program modules, or other data. For example, computer-storage media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the computer 700.

According to various embodiments, the computer 700 may operate in a networked environment using logical connections to remote computers through a network such as the network 106. The computer 700 may connect to the network 106 through a network interface unit 710 connected to the bus 706. It should be appreciated that the network interface unit 710 may also be utilized to connect to other types of networks and remote computer systems. The computer 700 may also include an input/output controller 708 for receiving and processing input from a number of input devices (not shown), including a keyboard, a mouse, a microphone, and a game controller. Similarly, the input/output controller 708 may provide output to a display or other type of output device (not shown).

The bus 706 may enable the processing unit 702 to read code and/or data to/from the mass storage device 712 or other computer-storage media. The computer-storage media may represent apparatus in the form of storage elements that are implemented using any suitable technology, including but not limited to semiconductors, magnetic materials, optics, or the like. The computer-storage media may represent memory components, whether characterized as RAM, ROM, flash, or other types of technology. The computer-storage media may also represent secondary storage, whether implemented as hard drives or otherwise. Hard drive implementations may be characterized as solid state, or may include rotating media storing magnetically-encoded information.

The program modules 714 may include software instructions that, when loaded into the processing unit 702 and executed, cause the computer 700 to analyze web traffic. The program modules 714 may also provide various tools or techniques by which the computer 700 may participate within the overall systems or operating environments using the components, flows, and data structures discussed throughout this description. For example, the program modules 714 may implement interfaces for analyzing web traffic.

In general, the program modules 714 may, when loaded into the processing unit 702 and executed, transform the processing unit 702 and the overall computer 700 from a general-purpose computing system into a special-purpose computing system customized to analyze web traffic. The processing unit 702 may be constructed from any number of transistors or other discrete circuit elements, which may individually or collectively assume any number of states. More specifically, the processing unit 702 may operate as a finite-state machine, in response to executable instructions contained within the program modules 714. These computer-executable instructions may transform the processing unit 702 by specifying how the processing unit 702 transitions between states, thereby transforming the transistors or other discrete hardware elements constituting the processing unit 702.

Encoding the program modules 714 may also transform the physical structure of the computer-storage media. The specific transformation of physical structure may depend on various factors, in different implementations of this description. Examples of such factors may include, but are not limited to: the technology used to implement the computer-storage media, whether the computer-storage media are characterized as primary or secondary storage, and the like. For example, if the computer-storage media are implemented as semiconductor-based memory, the program modules 714 may transform the physical state of the semiconductor memory, when the software is encoded therein. For example, the program modules 714 may transform the state of transistors, capacitors, or other discrete circuit elements constituting the semiconductor memory.

As another example, the computer-storage media may be implemented using magnetic or optical technology. In such implementations, the program modules 714 may transform the physical state of magnetic or optical media, when the software is encoded therein. These transformations may include altering the magnetic characteristics of particular locations within given magnetic media. These transformations may also include altering the physical features or characteristics of particular locations within given optical media, to change the optical characteristics of those locations. Other transformations of physical media are possible without departing from the scope of the present description, with the foregoing examples provided only to facilitate this discussion.

Based on the foregoing, it should be appreciated that technologies for analyzing web traffic are presented herein. Although the subject matter presented herein has been described in language specific to computer structural features, methodological acts, and computer readable media, it is to be understood that the invention defined in the appended claims is not necessarily limited to the specific features, acts, or media described herein. Rather, the specific features, acts and mediums are disclosed as example forms of implementing the claims.

The subject matter described above is provided by way of illustration only and should not be construed as limiting. Various modifications and changes may be made to the subject matter described herein without following the example embodiments and applications illustrated and described, and without departing from the true spirit and scope of the present invention, which is set forth in the following claims.

What is claimed is:

1. A computer-implemented method for analyzing web traffic, the method comprising computer-implemented operations for:
receiving a log file including a line, the line corresponding to a request received at a web server;
receiving a rules file including a sequence of rules that are applied in a specified order, the sequence of rules associated with a plurality of request identifiers, the sequence of rules including a first rule associated with a first request identifier and a second rule associated with a second request identifier;
determining whether the line matches the first rule;
in response to determining that the line matches the first rule, updating identification data to associate the first request identifier with the line;
in response to determining that the line does not match the first rule, determining whether the line matches the second rule; and
in response to determining that the line matches the second rule, updating the identification data to associate the second request identifier with the line.

2. The computer-implemented method of claim 1, wherein log file further includes a second line, the second line corresponding to a second request received at the web server; and the method comprising further computer-implemented operations for:
upon updating the identification data to associate the first request identifier with the line, determining whether the second line matches the first rule;
in response to determining that the second line matches the first rule, updating identification data to associate the first request identifier with the second line;
in response to determining that the second line does not match the first rule, determining whether the second line matches the second rule; and
in response to determining that the second line matches the second rule, updating the identification data to associate the second request identifier with the second line.

3. The computer-implemented method of claim 1, wherein the first rule includes a plurality of field conditions; and wherein determining whether the line matches the first rule comprises determining whether the line satisfies each of the plurality of field conditions.

4. The computer-implemented method of claim 1, wherein the first rule includes a plurality of field conditions; and wherein determining whether the line matches the first rule comprises determining whether the line satisfies at least one of the plurality of field conditions.

5. The computer-implemented method of claim 1, wherein the line includes a plurality of values, each of the plurality of values corresponding to one of a plurality of fields; wherein the first rule includes a field element identifying a field from the plurality of fields, a predicate element specifying a predicate, and a pattern element specifying a pattern; and wherein determining whether the line matches the first rule comprises:
extracting the field, the predicate, and the pattern from the first rule;
retrieving a value from the plurality of values corresponding to the extracted field; and
determining whether the retrieved value and the extracted pattern have a relation according to the extracted predicate.

6. The computer-implemented method of claim 5, wherein the value comprises a number, and the pattern comprises a number.

7. The computer-implemented method of claim 5, wherein the value comprises a string, and the pattern comprises a string.

8. The computer-implemented method of claim 1, the method comprising further computer-implemented operations for generating an output file based on the identification data.

9. The computer-implemented method of claim 8, wherein the output file associates a count and a ratio with each of the plurality of request identifiers, the count specifying a number of times that a corresponding request is received at the web server, the ratio specifying the number of times that the corresponding request is received at the web server in relation to a total number of requests received at the web server.

10. The computer-implemented method of claim 1, wherein the first rule and the second rule are encoded in Extensible Markup Language (XML).

11. A computer system, comprising:
a processor;
a memory communicatively coupled to the processor; and
a web traffic analysis tool (i) which executes in the processor from the memory and (ii) which, when executed by the processor, causes the computer system to analyze web traffic by
receiving a log file including a first line and a second line, the first line corresponding a first request received at a web server, the second line corresponding to a second request received at the web server,
receiving a rules file including a sequence of rules that are applied in a specified order, the sequence of rules associated with a plurality of request identifiers, the sequence of rules including a first rule associated with a first request identifier and a second rule associated with a second request identifier,
determining whether the first line matches the first rule,
in response to determining that the first line matches the first rule, updating identification data to associate the first request identifier with the first line,
in response to determining that the first line does not match the first rule, determining whether the first line matches the second rule,
in response to determining that the first line matches the second rule, updating the identification data to associate the second request identifier with the first line,
upon updating the identification data to associate the first request identifier with the first line, determining whether the second line matches the first rule,
in response to determining that the second line matches the first rule, updating identification data to associate the first request identifier with the second line,
in response to determining that the second line does not match the first rule, determining whether the second line matches the second rule, and
in response to determining that the second line matches the second rule, updating the identification data to associate the second request identifier with the second line.

12. The computer system of claim 11, wherein the log file comprises a text file or a binary file.

13. The computer system of claim 11, wherein the first line and the second line are separated by a carriage return (CR) or a carriage return line feed (CRLF).

14. The computer system of claim 11, wherein the first rule includes a plurality of field conditions; wherein determining whether the first line matches the first rule comprises determining whether the first line satisfies each of the plurality of field conditions; and wherein determining whether the second line matches the second rule comprises determining whether the second line satisfies each of the plurality of field conditions.

15. The computer system of claim 11, wherein the first rule includes a plurality of field conditions; wherein determining whether the first line matches the first rule comprises determining whether the first line satisfies at least one of the plurality of field conditions; and wherein determining whether the second line matches the second rule comprises determining whether the second line satisfies at least one of the plurality of field conditions.

16. The computer system of claim 11, wherein the first line includes a plurality of values, each of the plurality of values corresponding to one of a plurality of fields; wherein the first rule includes a field element identifying a field from the plurality of fields, a predicate element specifying a predicate, and a pattern element specifying a pattern; and wherein determining whether the first line matches the first rule comprises:
extracting the field, the predicate, and the pattern from the first rule;
retrieving a value from the plurality of values corresponding to the extracted field; and
determining whether the retrieved value and the extracted pattern have a relation according to the extracted predicate.

17. The computer system of claim 16, wherein each of the plurality of values in the first line are separated by whitespace.

18. The computer system of claim 11, wherein the web traffic analysis tool, when executed by the processor, further causes the computer system to analyze web traffic by generating an output file based on the identification data, the output file associating a count and a ratio with each of the plurality of request identifiers, the count specifying a number of times that a corresponding request is received at the web server, the ratio specifying the number of times that the corresponding request is received at the web server in relation to a total number of requests received at the web server.

19. A computer-readable storage medium having computer-executable instructions stored thereon which, when executed by a computer, cause the computer to:
receiving a log file including a first line and a second line, the first line corresponding a first request received at a web server, the second line corresponding to a second request received at the web server,
receive a rules file including a sequence of rules that are applied in a specified order, the sequence of rules associated with a plurality of request identifiers, the sequence of rules including a first rule associated with a first request identifier and a second rule associated with a second request identifier, the first rule comprising a first set of field conditions, the second rule comprising a second set of field conditions;
determine whether the first line matches the first rule by determining whether the first line satisfies each of the first set of field conditions;
in response to determining that the first line matches the first rule, update identification data to associate the first request identifier with the first line;
in response to determining that the first line does not match the first rule, determine whether the first line matches the second rule by determining whether the first line satisfies each of the second set of field conditions;
in response to determining that the first line matches the second rule, update the identification data to associate the second request identifier with the first line;
upon updating the identification data to associate the first request identifier with the line, determine whether the second line matches the first rule by determining whether the second line satisfies each of the first set of field conditions;
in response to determining that the second line matches the first rule, update identification data to associate the first request identifier with the second line;
in response to determining that the second line does not match the first rule, determine whether the second line matches the second rule by determining whether the second line satisfies each of the second set of field conditions; and
in response to determining that the second line matches the second rule, update the identification data to associate the second request identifier with the second line.

20. The computer-readable storage medium of claim 19, wherein the first line includes a plurality of values, each of the plurality of values corresponding to one of a plurality of fields; wherein the first set of field conditions comprises a first field condition and a second field condition; wherein the first field condition includes a first field element identifying a first field from the plurality of fields, a first predicate element specifying a first predicate, and a first pattern element specifying a first pattern; wherein the second field condition includes a second field element identifying a second field from the plurality of fields, a second predicate element specifying a second predicate, and a second pattern element specifying a second pattern; and wherein to determine whether the first line matches the first rule, the computer-readable storage medium having further computer-executable instructions stored thereon which, when executed by the computer, cause the computer to:
extract the first field, the first predicate, and the first pattern from the first field condition;
retrieve a first value from the plurality of values corresponding to the extracted first field;
determine whether the retrieved first value and the extracted first pattern have a first relation according to the extracted first predicate;
extract the second field, the second predicate, and the second pattern from the second field condition;
retrieve a second value from the plurality of values corresponding to the extracted second field; and
determine whether the retrieved second value and the extracted second pattern have a second relation according to the extracted second predicate.
